(19) United States
(12) Patent Application Publication
(10) Pub. No.: US 2015/0077410 A1
(43) Pub. Date: Mar. 19, 2015

(54) DISPLAY APPARATUS, POWER SUPPLY CONTROL APPARATUS AND METHOD FOR CONTROLLING THEREOF

(71) Applicant: SAMSUNG ELECTRONICS CO., LTD., Suwon-si (KR)

(72) Inventor: Young-dae KIM, Suwon-si (KR)

(73) Assignee: SAMSUNG ELECTRONICS CO., LTD., Suwon-si (KR)

(21) Appl. No.: 14/275,982

(22) Filed: May 13, 2014

(30) Foreign Application Priority Data
Sep. 16, 2013 (KR) 10-2013-0111298

(51) Int. Cl. G09G 3/36

(52) U.S. Cl. CPC G09G 3/3696
USPC 345/212

(57) ABSTRACT

A display apparatus is provided. The display apparatus includes an interface configured to receive a data enable signal and a data signal, a power supply configured to supply power to an internal component, and a controller configured to determine whether to supply power to the internal component based on whether the data enable signal is received from an external apparatus through the interface, and configured to control the power supply to supply the power to the internal component based on the determination.

### CROSS-REFERENCE TO RELATED APPLICATION

This application claims priority from Korean Patent Application No. 10-2013-0111298, filed on Sep. 16, 2013 in the Korean Intellectual Property Office, the disclosure of which is incorporated herein by reference in its entirety.

### BACKGROUND

1. Field

Systems, methods, and apparatuses consistent with exemplary embodiments relate to a display apparatus, a power supply control apparatus, and a method for controlling thereof, and more particularly, to a display apparatus, a power supply control apparatus, and a method for controlling thereof for reducing power consumption.

2. Description of the Related Art

Developments in semiconductor technologies have provided the ability to create a system on a chip or system on chip (SOC). Specifically, main components of a display apparatus, for example, individual components such as a microprocessor, a memory semiconductor, a digital signal processor, a micro controller, and the like may be embodied in a SOC which performs operations in the form of a single chip.

A SOC, which may include a plurality of components, may help when attempting to embody a display apparatus within a smaller size area, resolve a noise issue which occurs between separate component chips, and/or reduce an amount of power consumption due to information exchange between chips by, for example, minimizing a space on a circuit board.

Further, various technologies for reducing power consumption of a display apparatus have been developed, and other improvement plans for reducing the power consumption may also be currently under development.

However, such improvement plans are limited to a method of minimizing power supply to periphery component configurations within a display apparatus (for example, a method for controlling an output of a display or a speaker and the like).

That is, there is a limit in minimizing power consumption based solely on conventional improvement plans. Accordingly, in order to minimize the power consumption amount of a display apparatus, it is possible to seek out various improvement plans for reducing the power consumption of a SOC as well as the periphery component configurations of the display apparatus.

### SUMMARY

According to an aspect of an exemplary embodiment, there is provided a display apparatus including an interface configured to receive a data enable signal and a data signal, a power supply configured to supply power to an internal component, and a controller configured to determine whether to supply power to the internal component based on whether the data enable signal is received from an external apparatus through the interface, and configured to control the power supply to supply the power to the internal component based on the determination.

The external apparatus may be configured to provide external power, wherein the controller may be further configured to determine whether the data enable signal is received from the external apparatus in response to a voltage outputted through a Low-Dropout (LDO) regulator changing from a first level voltage to a second level voltage.

The internal component may be a signal processor configured to perform signal processing of the data signal, and is mounted within a System On Chip (SOC), wherein the controller may determine whether to supply power to the signal processor based on whether the data enable signal is received.

The power supply may include a first power supply configured to supply power to the SOC, and a second power supply configured to only supply power to other components of the display apparatus.

According to an aspect of another exemplary embodiment, there is provided a power supply control apparatus configured to supply power to an internal component of a display apparatus, the power supply control apparatus including an interface configured to receive a data enable signal and a data signal, a determining unit configured to determine whether the data enable signal is received from an external apparatus through the interface, and a controller configured to determine whether to supply power to the internal component according to the determination of the determining unit.

The external apparatus may be configured to provide external power, wherein the determining unit may be a Low-Dropout (LDO) regulator.

The internal component may be a signal processor configured to perform signal processing of the data signal, and is mounted within a System On Chip (SOC), wherein the controller may be further configured to control the power supply to supply power to the signal processor in response to the data enable signal being received, and control the power supply to cut off power to the signal processor in response to the data enable signal not being received.

According to an aspect of another exemplary embodiment, there is provided a method for controlling a display apparatus, the method including determining whether a data enable signal is received from an external apparatus through an interface, supplying power that is supplied by a power supply to an internal component when it is determined that the data enable signal is received, and performing signal processing of a data signal received from the external apparatus using the internal component.

The external apparatus may be configured to provide external power, wherein the determining includes determining whether the data enable signal is received from the external apparatus in response to a voltage outputted through a Low-Dropout (LDO) regulator is changing from a first level voltage to a second level voltage.

The internal component may be a signal processor configured to perform signal processing of the data signal, and is mounted within a System On Chip (SOC), wherein the determining may include determining whether to supply power to the signal processor based on whether the data enable signal is received.

The supplying may include supplying power from a first power supply to the SOC, and supplying power from a second power supply only to other components.

According to an aspect of another exemplary embodiment, there is provided a method for controlling a supply of power to an internal component of a display apparatus, the method including determining whether a data enable signal is received from an external apparatus through an interface, deciding whether to supply power to the internal component based on whether the data enable signal is received, and controlling a supply of power to the internal component according to the decision.

The external apparatus may be configured to provide external power, wherein the determining may include determining whether the data enable signal is received from the external apparatus in response to a voltage outputted through a Low-Dropout (LDO) regulator changing from a first level voltage to a second level voltage.

The internal component may be a signal processor configured to perform signal processing of a data signal, and is mounted within a System On Chip (SOC), wherein controlling the supply of power to the internal component in response to receiving the data enable signal may include supplying power from the power supply to the signal processor, and wherein controlling the supply of power to the internal component in response to not receiving the data enable signal may include cutting off power to the signal processor.

### BRIEF DESCRIPTION OF THE DRAWINGS

The above and/or other aspects will be more apparent and more readily appreciated from the following description of exemplary embodiments taken in conjunction with the accompanying drawings, in which:

FIG. 1 is block diagram of a display apparatus according to an exemplary embodiment;

FIG. 2 is a block diagram of a power supply control apparatus according to an exemplary embodiment;

FIG. 3 is a flowchart illustrating a control method of the display apparatus according to an exemplary embodiment; and

FIG. 4 is a flowchart illustrating a method for controlling power supply to an internal component by the power supply control apparatus according to an exemplary embodiment.

### DETAILED DESCRIPTION OF THE PREFERRED EMBODIMENT

Certain exemplary embodiments are described in greater detail below with reference to the accompanying drawings. In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail because they would obscure the application with unnecessary detail.

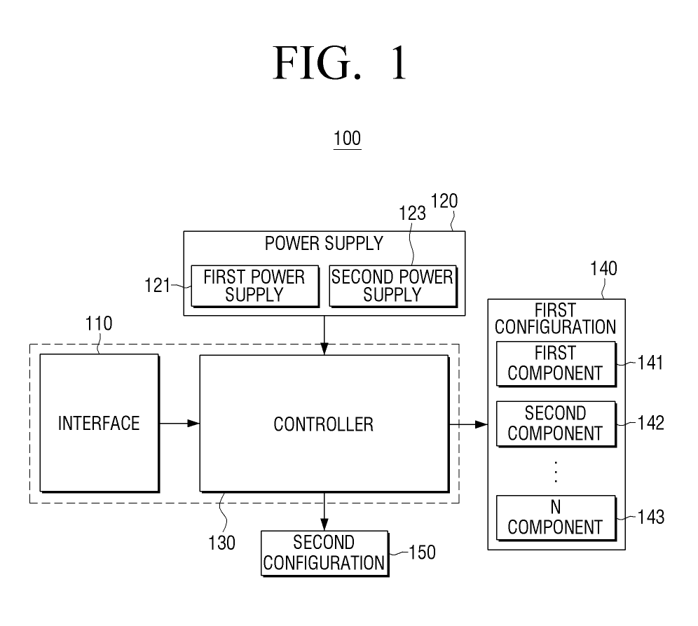

FIG. 1 is block diagram of a display apparatus according to an exemplary embodiment. According to one or more exemplary embodiments, as illustrated in FIG. 1, a display apparatus 100 may be a terminal apparatus such as a smart TV, and may include an interface 110, a power supply 120, and a controller 130.

The interface 110 may receive a data signal by being connected to an external apparatus. An external apparatus may be an apparatus that is capable of providing external power, and may be a terminal apparatus which connects to the display apparatus using a High Definition Multimedia Interface (HDMI) such as a digital disc player, a digital media forwarding device or a personal computer (PC). Accordingly, the interface 110 may receive a data signal by being connected to such an external apparatus by a cable.

The power supply 120 supplies power to at least one internal component. Alternatively, the power supply 120 may supply power to all components included in the display apparatus. The power supply 120 may include a first power supply 121 and a second power supply 123. The first power supply 121 may supply power to a first configuration 140 including a first through n components 141 through 143, and the second power supply 143 may supply power to a second configuration 150.

According to an exemplary embodiment, the first configuration 140 may be a SOC, and the first through n components 141 through 143 included in the first configuration 140 may be components of at least one of a Central Processing Unit (CPU), a Graphic Processing Unit (GPU), and a signal processor for various data. The second configuration 150 may be a configuration which include other components except for the SOC, and may include, for example, a storage, a tuner, a display, a speaker, and the like. Accordingly, the first power supply 121 may supply power to the SOC, and the second power supply 123 may supply power to other components except for the SOC.

The SOC, which may operate by being supplied with power by the first power supply 121, may be a semiconductor which performs all functions by a single chip, and may include at least one of the CPU, the GPU, and the signal processor for various data, which are the first through n components 141 through 143 as specified above. Accordingly, the first power supply 121 may supply power to each component mounted within the SOC.

The controller 130 may be configured to control overall operations of each component of the display apparatus 100. Specially, the controller 130 may decide whether to supply power to an internal component according to whether a data enable signal is received from an external apparatus through the interface 110. When a data enable signal is received the controller 130 may then control the power supply 120 such that it supplies power to the internal component.

An internal component may be a signal processor which performs a signal processing of a data signal received from an external apparatus through the interface 110. The signal processor may be mounted within the SOC. Accordingly, the controller 130 may determine whether to supply power to the signal processor mounted within the SOC according to whether a data enable signal is received from an external apparatus through the interface 110.

According to an exemplary embodiment, the controller 130 may determine whether a data enable signal is received from an external apparatus according to whether a voltage outputted through a low-dropout regulator (LDO) is changed from a first level voltage to a second level voltage. However, the present disclosure is not limited thereto, and the controller 130 may determine whether an output voltage is changed by using other elements such as a Direct Current-Direct Current (DC-DC) converter.

For example, when a data enable signal is not received from an external apparatus, the LDO regulator may maintain a level voltage of 0V. The external apparatus may transmit a data signal while being connected to the interface 110 of the display apparatus 100 by a cable. In this case, the external apparatus may transmit a data enable signal before transmitting the data signal. For example, the external apparatus may transmit a data enable signal of 5V, and when the data enable signal of 5V is received through the interface 110, the LDO regulator may change the level voltage of 0V to a level voltage of 3.3V.

When the voltage is changed from the predetermined first level voltage to the second level voltage through the LDO regulator, the controller 130 may determine that a data enable signal has been received from an external apparatus. Accordingly, the controller 130 may decide that power should be supplied to the signal processor that is an internal component, and may control the first power supply 121 to supply the power to the signal processor mounted within the SOC.

Particularly, the first power supply 121 may supply power to the first configuration 140 that is a SOC according to a control command from the controller 130, and the second power supply 123 may supply power to the second configuration 150.

According to an exemplary embodiment, the controller 130 may individually control the power supplied to the signal processor within a SOC which performs signal processing of a data signal received from an external apparatus, where the signal processor is one from among the first through n components 141 through 143 included in the first configuration 140 that is a SOC. Accordingly, the first power supply 121 may supply power only to a component corresponding to the signal processor which performs the signal processing of the data signal received from the external apparatus from among the first through n components 141 through 143 included in the first configuration 140 that is a SOC.

As specified above, the controller 130 which individually controls the power supply to the signal processor determines whether a data enable signal is received from an external apparatus. When it is determined that the data enable signal is received, the controller 130 controls the power which is supplied by the first power supply 121 to the signal processor. The signal processor enters into an active mode, which may also be called an activation mode, when the signal processor receives power from the power supply 121. Further, when a data signal is received from the external apparatus through the interface 110, the controller 130 transmits the received data signal to the signal processor. Accordingly, the signal processor in the activation mode may perform the signal processing of the data signal received from an external apparatus.

The controller 130 determines whether a data enable signal is periodically received while power is supplied to the signal processor. When it is determined that a data enable signal is received, the controller 130 maintains the power supply to the signal processor. When it is determined that the data enable signal is not received, the controller 130 may cut off the power supply to the signal processor.

That is, the display apparatus of the present disclosure may individually control the power supplied to the signal processor which performs a signal processing of a data signal received from an external apparatus according to a connection state between the external apparatus and the display apparatus, thereby preventing power from continuously being supplied to the signal processor which may not continuously perform the signal processing of the data signal. Accordingly, the display apparatus of the present disclosure may minimize the power consumption according to the power supply to an internal component according to the determined usage of that component.

The aforementioned interface 110 and the controller 130 may be embodied in a power supply control apparatus 200. Hereinafter, each component of the power supply control apparatus 200 is described in detail.

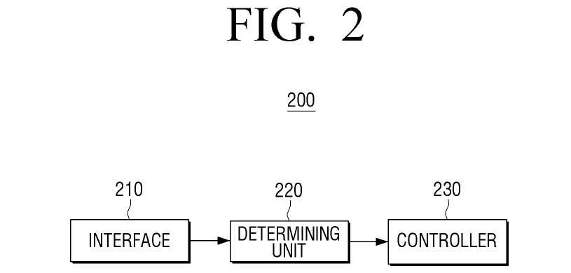

FIG. 2 is a block diagram of a power supply control apparatus according to an exemplary embodiment.

The power supply control apparatus 200, as illustrated in FIG. 2, may control power supply to one or more internal components and may be mounted within the display apparatus 100. The power supply control apparatus 200 may include an interface 210, a determining unit 220, and a controller 230.

The interface 210 receives a data signal by being connected to an external apparatus. Herein, as specified above, an external apparatus is an apparatus which is capable of providing external power, and may be a terminal apparatus with a HDMI connection, a PC, and the like. Accordingly, the interface 210 may receive a data signal by being connected to an external apparatus.

The determining unit 220 determines whether a data enable signal is received from an external apparatus through the interface 210, and the controller 230 decides whether to supply power to an internal component according to the determined result of whether a data enable signal is received.

The determining unit 220 which determines whether a data enable signal is received from an external apparatus through the interface 210 may be embodied in a LDO regulator element. When a data enable signal is received, the LDO regulator may change a level voltage from the first level voltage to the second level voltage. Accordingly, the controller 230 may determine whether the data enable signal is received from the external apparatus through the LDO regulator according to whether the level voltage has changed.

When it is determined that the data enable signal is received from the external apparatus, the controller 230 supplies the power which is supplied by the power supply to an internal component. The internal component may be a signal processor which performs a signal processing of a data signal received from an external apparatus through the interface 210. The signal processor may be mounted within the SOC.

Accordingly, when the determining unit 220 determines that the data enable signal is received from the external apparatus, the controller 230 may decide whether to supply power to the signal processor mounted within the SOC, and supply the power which is supplied by the power supply to the signal processor. The signal processor may enter into an active mode, which may also be called an activation mode, when the signal processor receives the power from the power supply. Further, when the data signal is received from the external apparatus through the interface 210, the controller 230 transmits the received data signal to the signal processor. Thus, the signal processor in the activation mode may perform the signal processing of the data signal received from the external apparatus through the controller 230.

According to another exemplary embodiment, the determining unit 220 may determine whether a data enable signal is periodically received from an external apparatus. When it is determined that a data enable signal is received, the determining unit 220 may determine that the controller 230 should maintain the power supply to the signal processor during the periodic time when a data enable signal is received. Further, when it is determined that the data enable signal is not received for a predetermined time, the controller 230 may cut off power which is supplied to the signal processor during the period downtime without reception.

That is, the power supply control apparatus of the present disclosure may individually control the power supplied to the signal processor which performs the signal processing of the data signal which is received from the external apparatus according to a connection state between the external apparatus and the display apparatus. Accordingly, the power supply control apparatus may prevent power from being continuously supplied to the signal processor which may not continuously perform the signal processing of the data signal.

Hereinafter, a control method of the display apparatus 100 is described in detail.

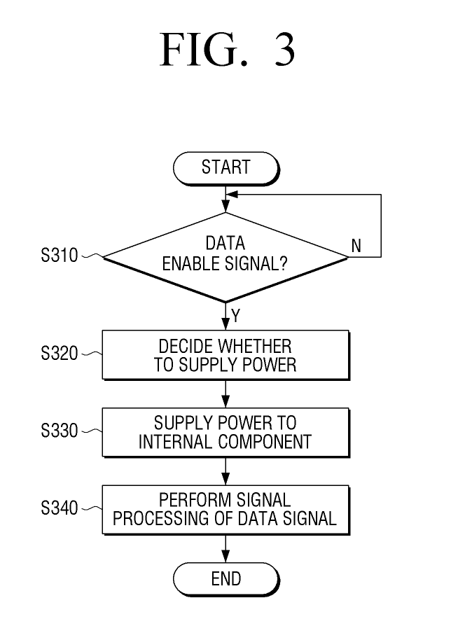

FIG. 3 is a flowchart illustrating a control method of the display apparatus according to an exemplary embodiment.

As illustrated in FIG. 3 with reference to FIG. 1, the display apparatus 100 determines whether a data enable signal is received from an external apparatus through an interface (S310). Subsequently, the display apparatus 100 decides whether to supply power to an internal component of the display apparatus 100 according to whether the data enable signal is received from the external apparatus, and supplies the power which is supplied by the power supply to the internal component according to the decision (S320 and S330). Subsequently, the display apparatus 100 performs the signal processing of the data signal received from the external apparatus through the internal component which is supplied with power (S340).

To be specific, the external apparatus may be connected to the interface of the display apparatus by a cable. Herein, an external apparatus is an apparatus which is capable of providing external power, and may be a terminal apparatus with a HDMI connection, a PC, and the like for example. Hence, the display apparatus 100 may receive a data signal from the external apparatus through the interface.

Before transmitting a data signal to the display apparatus 100, the external apparatus transmits a data enable signal to the display apparatus. Hence, the display apparatus 100 may determine whether the data enable signal is received from the external apparatus, and may decide whether to supply power to an internal component that may be tasked with processing the impending data signal which will be received after receiving the data enable signal.

To be specific, the display apparatus 100 may determine whether the data enable signal is received from the external apparatus according to whether a voltage outputted through the LDO regulator is changed from the first level voltage to the second level voltage. However, the present disclosure is not limited thereto, and the controller 130 may determine whether the output voltage is changed by using another element such as the DC-DC converter.

For example, when the data enable signal is not received from the external apparatus, the LDO regulator may maintain a level voltage of 0V. When a data enable signal of 5V is received from the external apparatus, the LDO regulator may change the level voltage of 0V to a level voltage of 3.3V.

The display apparatus 100 may determine whether the data enable signal is received from the external apparatus according to whether the level voltage is changed from the first level voltage to the second level voltage.

When it is determined that the data enable signal is received from the external apparatus, the display apparatus 100 may supply the power which is supplied by the power supply to an internal component. Herein, an internal component may be a signal processor which performs the signal processing of the data signal received from the external apparatus through the interface. The signal processor may be mounted within the SOC. Accordingly, when it is determined that the data enable signal is received from the external apparatus, the display apparatus supplies power to the signal processor mounted within the SOC.

To be specific, the display apparatus 100 may supply the power, which is supplied from the first power supply to the SOC, and supply the power which is supplied from the second power supply to other components besides the SOC. As specified above, a SOC may include at least one of the CPU, the GPU, and the signal processor for various data. In addition, the other components except for the SOC may include a storage, a tuner, a display, a speaker, and the like.

The display apparatus 100 may supply the power, which is supplied from the first power supply, to each component mounted within the SOC, and may supply the power, which is supplied from the second power supply, to the other components including a storage, a tuner, a display, a speaker, and the like.

When supplying the power from the first power supply to the SOC, the display apparatus 100 may supply the power from the first power supply to the signal processor mounted within the SOC and the other components in a different manner. That is, the display apparatus 100 may supply the power of the first power supply to the signal processor mounted within the SOC according to whether a data enable signal is received, and may continuously supply the power of the first power supply to the other components mounted within the SOC.

Specifically, the signal processor may enter into an activation mode according to when the power is supplied from the first power supply, and the display apparatus 100 may perform the signal processing of the data signal received from the external apparatus through the signal processor when it is in the activation mode.

The display apparatus of the present disclosure may individually control the power supplied to the signal processor which performs the signal processing of the data signal received from the external apparatus according to the connection state between the external apparatus and the display apparatus, and thus, may prevent power from being continuously sent into the signal processor thereby maintaining the signal processor in an unused inactivation mode. That is, the display apparatus may minimize the power consumption by controlling the power supply of an internal component.

Hereinafter, a method for controlling a power supply, that is, a method of how the power supply control apparatus included in the display apparatus 100 supplies power to an internal component is described in detail.

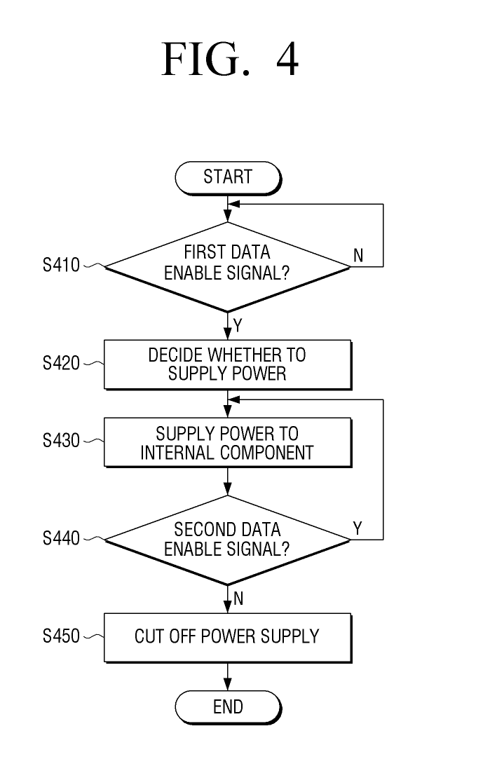

FIG. 4 is a flowchart illustrating a method for controlling power supply to an internal component by the power supply control apparatus according to an exemplary embodiment.

As illustrated in FIG. 4 with reference to FIG. 2, the power supply control apparatus 200 determines whether a first data enable signal is received from an external apparatus through the interface (S410). As specified above, an external apparatus may be an apparatus which is capable of providing external power. Accordingly, the power supply control apparatus 200 determines whether the first data enable signal is received from the external apparatus through the interface, and decides whether to supply power to an internal component of the display apparatus 100 based on the determined result (S420). Subsequently, the power supply control apparatus supplies power to the internal components of the display apparatus 100 according to the decision regarding the power supply (S430).

Herein, an internal component may be a signal processor which performs a signal processing of a data signal received from an external apparatus. The signal processor is mounted within the SOC. Accordingly, when the first data enable signal is received from the external apparatus, the power supply control apparatus 200 may supply power to the signal processor mounted within the SOC.

The SOC may include a plurality of components such as the CPU, the GPU, and the like in addition to the signal processor which performs the signal processing of the data signal received from the external apparatus. Other components other than the signal processor may be continuously supplied with power through the power supply of the display apparatus 100.

In the operation S410, the power supply control apparatus may determine whether the first data enable signal is received by determining whether a voltage outputted through the LDO regulator is the first level voltage or the voltage is changed from the first level voltage to the second level voltage. That is, when an output voltage outputted through the LDO regulator is changed from the first level voltage to the second level voltage, the power supply control apparatus 200 determines that the first data enable signal is received from the external apparatus. When the output voltage outputted through the LDO regulator is maintained as the first level voltage, the power supply control apparatus 200 may determine that the first data enable signal is not received from the external apparatus.

When the power supply control apparatus 200 determines that the first data enable signal is received, power may be supplied to the signal processor that is an internal component of the display apparatus 100. The power supply control apparatus 200 may further determine that a second data enable signal is received from the external apparatus in the same manner as in the operation S410 (S440). When it is determined that the second data enable signal is received, the power supply control apparatus 200 may supply power to the signal processor through the operation S430. When it is determined that the second data enable signal is not received, the power supply control apparatus 200 cuts off the power supply to the signal processor (S450).

The power supply control apparatus may individually control the power supply to the signal processor which performs the signal processing of the data signal which is received from the external apparatus according to the connection state between the external apparatus and the display apparatus. Hence, the power supply control apparatus may prevent power from being continuously supplied to the signal processor, by cutting the power supplied when the signal processor does not perform the signal processing of the data signal.

As given above, although a few desirable exemplary embodiments have been shown and described, the present disclosure is not limited to the aforementioned particular exemplary embodiments, and could be variously modified and achieved by those skilled in the art to which the present disclosure pertains without deviating from the substance of the present disclosure which is claimed in the claims, and such modifications should not be understood separately from the technical concept or prospect of the present disclosure.

What is claimed is:

1. A display apparatus comprising:
an interface configured to receive a data enable signal and a data signal;
a power supply configured to supply power to an internal component; and
a controller configured to determine whether to supply power to the internal component based on whether the data enable signal is received from an external apparatus through the interface, and configured to control the power supply to supply the power to the internal component based on the determination.

2. The display apparatus as claimed in claim 1,
wherein the external apparatus is configured to provide external power,
wherein the controller is further configured to determine whether the data enable signal is received from the external apparatus in response to a voltage outputted through a Low-Dropout (LDO) regulator changing from a first level voltage to a second level voltage.

3. The display apparatus as claimed in claim 1,
wherein the internal component is a signal processor configured to perform signal processing of the data signal, and is mounted within a System On Chip (SOC),
wherein the controller determines whether to supply power to the signal processor based on whether the data enable signal is received.

4. The display apparatus as claimed in claim 3, wherein the power supply comprises:
a first power supply configured to supply power to the SOC; and
a second power supply configured to only supply power to other components of the display apparatus.

5. A power supply control apparatus configured to supply power to an internal component of a display apparatus, the power supply control apparatus comprising:
an interface configured to receive a data enable signal and a data signal;
a determining unit configured to determine whether the data enable signal is received from an external apparatus through the interface; and
a controller configured to determine whether to supply power to the internal component according to a determination of the determining unit.

6. The power supply control apparatus as claimed in claim 5,
wherein the external apparatus is configured to provide external power,
wherein the determining unit is a Low-Dropout (LDO) regulator.

7. The power supply control apparatus as claimed in claim 5,
wherein the internal component is a signal processor configured to perform signal processing of the data signal, and is mounted within a System On Chip (SOC),
wherein the controller is further configured to control the power supply to supply power to the signal processor in response to the data enable signal being received, and control the power supply to cut off power to the signal processor in response to the data enable signal not being received.

8. A method for controlling a display apparatus, the method comprising:
determining whether a data enable signal is received from an external apparatus through an interface;
supplying power that is supplied by a power supply to an internal component when it is determined that the data enable signal is received; and
performing signal processing of a data signal received from the external apparatus using the internal component.

9. The method as claimed in claim 8,
wherein the external apparatus is configured to provide external power,
wherein the determining comprises determining whether the data enable signal is received from the external apparatus in response to a voltage outputted through a Low-Dropout (LDO) regulator is changing from a first level voltage to a second level voltage.

10. The method as claimed in claim 8,
wherein the internal component is a signal processor configured to perform signal processing of the data signal, and is mounted within a System On Chip (SOC),
wherein the determining comprises determining whether to supply power to the signal processor based on whether the data enable signal is received.

11. The method as claimed in claim 10, wherein the supplying comprises supplying power from a first power supply to the SOC, and supplying power from a second power supply only to other components.

12. A method for controlling a supply of power to an internal component of a display apparatus, the method comprising:
determining whether a data enable signal is received from an external apparatus through an interface;
deciding whether to supply power to the internal component based on whether the data enable signal is received; and
controlling a supply of power to the internal component according to the decision.

13. The method as claimed in claim 12, wherein the external apparatus is configured to provide external power, and
wherein the determining comprises determining whether the data enable signal is received from the external apparatus in response to a voltage outputted through a Low-Dropout (LDO) regulator changing from a first level voltage to a second level voltage.

14. The method as claimed in claim 12, wherein the internal component is a signal processor configured to perform signal processing of a data signal, and is mounted within a System On Chip (SOC),
wherein controlling the supply of power to the internal component in response to receiving the data enable signal comprises supplying power from the power supply to the signal processor, and
wherein controlling the supply of power to the internal component in response to not receiving the data enable signal comprises cutting off power to the signal processor.

15. A display apparatus comprising:
a component in a system on a chip (SOC) configured to process a data signal when the component is in an active mode;
a controller configured to place the component in the active mode by providing power using a power supply in response to receiving a data enable signal, and configured to withhold, from the component, power from the power supply in response to no data enable signal being received.

16. The display apparatus of claim 15, where in the component is a signal processor.

17. The display apparatus of claim 15, wherein the data signal is received from an external device through an interface.

18. The display apparatus of claim 15, wherein the data enable signal is received from an external device through an interface.

19. The display apparatus of claim 15, wherein the power supply comprises:
a first power supply configured to selectively provide power to at least one component in the SOC including the component; and
a second power supply configured to selectively provide power to other components of the display apparatus.
